(19) United States
(12) Patent Application Publication
(10) Pub. No.: US 2010/0292866 A1
(43) Pub. Date: Nov. 18, 2010

(54) METHOD AND DEVICE FOR OPERATING A MOTOR VEHICLE, METHOD AND DEVICE FOR ACCESSING AN ASSIGNMENT RULE AND COMPUTER-PROGRAM PRODUCT

(75) Inventors: Carl-Eike Hofmeister, Regensburg (DE); Michael Käsbauer, Neutraubling (DE); Ulrich Voll, Munchen (DE)

Correspondence Address: King & Spalding LLP, 401 Congress Avenue, Suite 3200, Austin, TX, 78701, US

(73) Assignee: Continental Automotive GmbH

(21) Appl. No.: 12/295,639

(22) PCT Filed: Mar. 20, 2007
(86) PCT No.: PCT/EP07/52659

§ 371 Date: Oct. 1, 2008

(30) Foreign Application Priority Data
Apr. 4, 2006 (DE) 10 2006 015 677.3

(51) Int. Cl. G06F 9/46; B60W 50/02

(52) U.S. Cl. 701/1

(57) ABSTRACT

To operate a motor vehicle (2) when at least one predefined event (EVE1) of a motor vehicle (2) occurs (ACT), at least one vehicle function (FCT) assigned to the predefined event (EVE1) is determined by assignment (LINK) via at least one first adjaceny list (AD_LIST1). Then, the determined vehicle function (FCT) is started or blocked.

### CROSS-REFERENCE TO RELATED APPLICATIONS

This application is a U.S. National Stage Application of International Application No. PCT/EP2007/052659 filed Mar. 20, 2007, which designates the United States of America, and claims priority to German Application No. 10 2006 015 677.3 filed Apr. 4, 2006, the contents of which are hereby incorporated by reference in their entirety.

### TECHNICAL FIELD

The invention relates to a method and a device for operating a motor vehicle wherein upon the occurrence of at least one predefined event of the motor vehicle at least one vehicle function assigned to the predefined event is determined. The determined vehicle function will be started or blocked. The invention further relates to a method and a device for accessing an assignment rule of a control device of the motor vehicle. The invention further relates to a computer-program product that includes a computer-readable medium having program instructions.

### BACKGROUND

In programmable control devices employed in the automotive domain, suitably assigned vehicle functions, for example emergency-operation modes, diagnostic strategies, and/or substitute-value calculations, are activated or deactivated as a function of predefined events, for example fault events, within the scope of the diagnostic processes prescribed by law. Said assignments of the vehicle functions to the predefined events are integrated within the scope of an assignment rule in software and stored in the control devices. The software is regularly supplied by the control-device manufacturers to automobile manufacturers who install the control devices in their motor vehicles.

The assignments of the vehicle functions to the predefined events are hence immutably fixed. The assignments of the vehicle functions to the predefined events can therefore be changed only by the manufacturers of the control devices. That gives rise to considerable costs and considerable time delays in the motor vehicles' development.

### SUMMARY

A method and a device can be provided that will both enable a motor vehicle to be operated in a simple manner.

According to an embodiment, a method for operating a motor vehicle may comprise the steps of: upon the occurrence of at least one predefined event of the motor vehicle:—determining an event entry assigned to the predefined event in an event list as a function of the predefined event,—determining a first adjacence list assigned to the determined event entry and comprising at least one adjacence-list entry as a function of the determined event entry,—determining a vehicle-function entry assigned to the corresponding adjacence-list entry in the first adjacence list and to the predefined vehicle function for each adjacence-list entry in the first adjacence list,—determining the predefined vehicle function as a function of the vehicle-function entry,—starting or blocking the determined vehicle function.

According to a further embodiment,—an event-set entry assigned to the adjacence-list entry in the first adjacence list and to a predefined event set containing the predefined event and at least one further predefined event can be determined as a function of the adjacence-list entry in the first adjacence list,—a second adjacence list assigned to the determined event-set entry and containing the at least one adjacence-list entry in the second adjacence list can be determined as a function of the determined event set,—the vehicle-function entry assigned to the corresponding adjacence-list entry in the second adjacence list and to the corresponding vehicle function can be determined for each adjacence-list entry in the second adjacence list. According to a further embodiment,—the first adjacence list can be determined and also a third adjacence list, assigned to the determined event entry and containing at least one adjacence-list entry, as a function of the determined event entry,—a corresponding vehicle-function entry assigned to the adjacence-list entry in the first adjacence list or, as the case may be, to the adjacence-list entry in the third adjacence list can be determined for each adjacence-list entry in the first adjacence list and for each adjacence-list entry in the third adjacence list, with the first adjacence list being able to be changed and the third adjacence list being unable to be changed. According to a further embodiment,—an event counter assigned to the vehicle-function entry and representative of a number of predefined events assigned to the determined function entry and having already occurred can be adjusted for each determined vehicle-function entry,—the corresponding vehicle function will be started or, as the case may be, blocked if the number is greater than zero. According to a further embodiment, a status value assigned to the predefined vehicle function and to the corresponding event counter can be adjusted if the corresponding event counter is greater than zero and the predefined vehicle function can be started or blocked as a function of the status value. According to a further embodiment, the predefined event can be classified as having occurred only if the predefined event having occurred fulfills at least one predefined condition. According to a further embodiment, the predefined event can be classified as having occurred only if the predefined event having occurred has occurred for a predefined first period of time. According to a further embodiment, the predefined event can be classified as having occurred only if the predefined event has occurred with a predefined frequency. According to a further embodiment, the number of predefined events having occurred which the event counter is able to count may be limited by a maximum number and wherein an auxiliary event counter will be started if the number of predefined events for the corresponding vehicle function that have occurred is greater than the maximum number. According to a further embodiment,—a check can be carried out on a predefined set of predefined events when a control device of the motor vehicle starts, in order to determine which is the current predefined event,—the vehicle function assigned to the current predefined event having occurred can be determined,—the event counter assigned to the vehicle function can be adjusted accordingly. According to a further embodiment, to determine whether the vehicle function has been correctly assigned to the predefined event via at least one of: the first and second adjacence list, a check can be carried out by at least one of the following steps:—checking for the current predefined event having occurred whether the number of predefined events having occurred to which the vehicle function has been assigned and which have been counted by the corresponding event counter is greater than zero,—checking whether the number of predefined events having occurred to which the vehicle function has been assigned and which have been counted by the corresponding event counter is zero or greater than zero,—shortly before the motor vehicle motor vehicle is switched off, decrementing the corresponding event counter by one unit for each vehicle function per predefined event having occurred and checking whether the number of predefined events having occurred is zero after decrementing, and—checking whether the number of predefined events having occurred to which the vehicle function (FCT) has been assigned and which have been counted by the corresponding event counter corresponds to the actual number of predefined events having occurred. According to a further embodiment, the control device can be restarted if the vehicle function has been incorrectly assigned to the predefined event via at least one of: the first and second adjacence list. According to a further embodiment, a fault in the control device can be classified as a predefined event having occurred if the vehicle function has been incorrectly assigned to the predefined event via at least one of: the first and second adjacence list.

According to another embodiment, a device for operating a motor vehicle, may be operable, upon the occurrence of at least one predefined event of the motor vehicle,—to determine an event entry, assigned to the predefined event, in an event list as a function of the predefined event,—to determine a first adjacence list, assigned to the event entry and containing at least one adjacence-list entry, as a function of the determined event entry,—to determine a vehicle-function entry, assigned to the predefined vehicle function and to the corresponding adjacence-list entry in the first adjacence list, for each adjacence-list entry in the first adjacence list,—to determine the predefined vehicle function as a function of the vehicle-function entry, and—to start or block the determined vehicle function.

According to another embodiment, a method for accessing an assignment rule of a control unit of a motor vehicle, wherein the assignment rule comprises at least one assignment by means of which at least one vehicle function of the motor vehicle has been assigned to at least one predefined event of the motor vehicle via at least one first adjacence list stored on a memory device of the control unit, may comprise the steps of:—when the assignment rule is read-accessed:—starting a read-access function which via the first adjacence list determines the assignment of the vehicle function to the predefined event,—when the assignment rule is write-accessed:—carrying out a check to determine whether the assignment, requiring to be written, of the vehicle function to the predefined event exists,—starting a write-access function that will adjust the first adjacence list as a function of the assignment requiring to be written if the assignment of the vehicle function to the predefined event does not exist.

According to a further embodiment, when the assignment rule is read-accessed:—a condition parameter can be determined that is assigned to a predefined condition assigned to the predefined event and to the assigned vehicle function in such a way that the assigned vehicle function will be started or blocked only if the predefined event fulfills the condition, with the condition parameter having been assigned to the assignment of the vehicle function to the predefined event,—when the assignment rule is write-accessed:—the condition parameter can be assigned to the corresponding assignment, requiring to be written, of the vehicle function to the predefined event. According to a further embodiment, a length of at least one of: the first adjacence list, the second adjacence list and a number of the adjacence lists may be predefined during write accessing. According to a further embodiment, the assignments of a plurality of vehicle functions to in each case at least one of the predefined events can be adjusted during write accessing and the adjacence lists can be adjusted accordingly during the one instance of write accessing. According to a further embodiment,—when the assignment rule is read-accessed:—the determined assignment of the vehicle function to the predefined event can be written by the read-access function to the memory device as an array,—the array with the assignment of the vehicle function to the predefined event can be read;—when the assignment rule is write-accessed:—the assignment, requiring to be written, of the vehicle function to the predefined event can be written to the memory device as an array,—a check can be carried out to determine whether the assignment requiring to be written exists as a function of the array,—the write-access function can be started that will adjust the first adjacence list as a function of the array if the assignment of the vehicle function to the predefined event does not exist. According to a further embodiment, the assignment of a plurality of vehicle functions to the predefined event can be written to the memory device in a manner distributed among a plurality of arrays. According to a further embodiment, a regular check can be carried out on expiration of a predefined second period of time to determine whether the array on the memory device has been updated and wherein the array will be read and/or wherein the adjacence lists will be adjusted as a function of the array if the array has been updated.

According to another embodiment, a device for accessing an assignment rule of a control unit of a motor vehicle, with the assignment rule comprising at least one assignment by means of which at least one vehicle function of the motor vehicle has been assigned to at least one predefined event of the motor vehicle via at least one first adjacence list stored on a memory device of the control unit,

May be operable,—when the assignment rule is read-accessed, to start a read-access function which via the first adjacence list determines the assignment of the vehicle function to the predefined event,—when the assignment rule is write-accessed,—to check whether the assignment, requiring to be written, of the vehicle function to the predefined event exists,—to start a write-access function that will adjust the first adjacence list as a function of the assignment requiring to be written if the assignment of the vehicle function to the predefined event does not exist.

According to another embodiment, a computer-program product comprising a computer-readable medium having program instructions which when executed by a computer may perform the step of producing at least one first adjacence list as a function of a matrix—whose row values are representative of at least one predefined event of a motor vehicle or of at least one predefined vehicle function of a motor vehicle and whose column values are representative of at least one of: at least one predefined vehicle function and at least one predefined event and—by means of which the vehicle function has been assigned to the predefined event.

### BRIEF DESCRIPTION OF THE DRAWINGS

The invention is explained in more detail below with the aid of the schematic.

FIG. 1 shows a motor vehicle,

FIG. 2 shows a first adjacence-list representation,

FIG. 3 shows a second adjacence-list representation,

FIG. 4 shows a third adjacence-list representation,

FIG. 5 shows a first representation of accessing an assignment rule,

FIG. 6 shows a second representation of accessing the assignment rule,

FIG. 7 shows a first program for determining a vehicle function,

FIG. 8 shows a second program for determining the vehicle function,

FIG. 9 shows a third program for determining the vehicle function,

FIG. 10 shows a first program for activating and/or deactivating the vehicle function,

FIG. 11 shows a first program for determining a status value,

FIG. 12 shows a second program for activating and/or deactivating the vehicle function,

FIG. 13 shows a first program for checking an assignment,

FIG. 14 show a second program for checking the assignment,

FIG. 15 shows a first program for reading the assignment,

FIG. 16 shows a first program for writing the assignment,

FIG. 17 shows a second program for reading the assignment,

FIG. 18 shows a second program for writing the assignment.

Elements having the same physical design or function are identified in all figures by the same reference numerals/letters.

### DETAILED DESCRIPTION

According to various embodiments, in a method and a device for operating a motor vehicle, when at least one predefined event of the motor vehicle has occurred, an event entry assigned to the predefined event is determined in an event list as a function of the predefined event. A first adjacence list assigned to the determined event entry is determined as a function of the determined event entry. The first adjacence list contains at least one adjacence-list entry. A vehicle-function entry is determined for each adjacence-list entry in the first adjacence list. The vehicle-function entry has been assigned to the corresponding adjacence-list entry and to the predefined vehicle function. The predefined vehicle function is determined as a function of the vehicle-function entry. The determined vehicle function will be started or blocked.

That will contribute to storing the assignment rule comprising the vehicle functions' assignment to the predefined events in a memory device of a control device of the motor vehicle in a manner requiring little space and to being able to quickly access the vehicle functions' assignment to the predefined events. Accessing means in this context reading and/or writing the assignment from/to the memory device. It will furthermore enable the vehicle function's assignment to the predefined event to be changed in a simple manner. It will furthermore make it easy to tell when the vehicle function has to be started or blocked.

According to an embodiment, an event-set entry is determined that has been assigned to a predefined event set. The predefined event set comprises the predefined event and at least one other predefined event. The event-set entry has been assigned to the adjacence-list entry and is determined as a function of the adjacence-list entry in the first adjacence list. A second adjacence list is determined as a function of the determined event-set entry. The second adjacence list has been assigned to the determined event-set entry and comprises at least one adjacence-list entry in the second adjacence list. The vehicle-function entry that has been assigned to the corresponding adjacence-list entry in the second adjacence list and to the corresponding vehicle function is determined for each adjacence-list entry in the second adjacence list. That will make it easy to assign the corresponding vehicle function to the event set.

According to a further embodiment, the first adjacence list is determined and also a third adjacence list, assigned to the determined event entry, as a function of the determined event entry. The third adjacence list contains at least one adjacence-list entry. A corresponding vehicle-function entry assigned to the corresponding adjacence-list entry is determined for each adjacence-list entry in the first adjacence list and each adjacence-list entry in the third adjacence list. The first adjacence list can be changed; the third adjacence list cannot be changed. That will make it easy to temporarily change the event's assignment to the vehicle function and/or to quickly change over between a changed and an unchanged assignment.

According to a further embodiment, an event counter assigned to the vehicle-function entry and representative of a number of predefined events assigned to the determined function entry and having already occurred is adjusted for each determined vehicle-function entry. The corresponding vehicle function will be started or blocked if the number is greater than zero. That will make it easy to tell whether the corresponding vehicle function is to be started or blocked.

According to a further embodiment, a status value will be adjusted if the corresponding event counter is greater than zero. The status value has been assigned to the respective vehicle function and to the corresponding event counter. The respective vehicle function will be started or blocked as a function of the status value. That will make it especially easy and quick to tell whether the corresponding vehicle function is to be started or blocked.

According to a further embodiment, the predefined event will be classified as having occurred only if the predefined event having occurred fulfills at least one predefined condition. That will make it possible to rate the event having occurred and to classify it under the predefined condition as an event having occurred as a function of which the vehicle function is to be started or blocked.

According to a further embodiment, the predefined event will be classified as having occurred only if the predefined event having occurred has occurred for a predefined first period of time. That will contribute to classifying the event especially precisely.

According to a further embodiment, the predefined event will be classified as having occurred only if the predefined event has occurred with a predefined frequency. That will contribute to classifying the event especially precisely.

According to a further embodiment, the number of predefined events having occurred which the event counter is able to count is limited by a maximum number of predefined events having occurred. An auxiliary event counter will be started if the number of predefined events for the corresponding vehicle function that have occurred is greater than the maximum number of predefined events having occurred. That can contribute to a low space requirement.

According to a further embodiment, a check is carried out on a predefined set of predefined events when a control device of the motor vehicle starts, in order to determine which is the current predefined event having occurred. The vehicle function assigned to the current predefined event having occurred is determined. The event counter assigned to the vehicle function is adjusted accordingly. That will enable all event counters to indicate the correct number of events having occurred for each vehicle function without delay after the motor vehicle starts.

According to a further embodiment, a check is carried out to determine whether the vehicle function has been correctly assigned to the predefined event via the first and/or second adjacence list. The assignment is checked by performing a check for the current predefined event having occurred to determine whether the number of predefined events having occurred to which the vehicle function has been assigned and which have been counted by the corresponding event counter is greater than zero. It is alternatively or additionally possible to check whether the number of predefined events having occurred to which the vehicle function has been assigned and which have been counted by the corresponding event counter is zero or greater than zero. It is alternatively or additionally possible shortly before the motor vehicle is switched off to decrement the corresponding event counter for the vehicle function by one unit per predefined event having occurred. A check will then be carried out to determine whether the number of predefined events having occurred is zero after decrementing. It is alternatively or additionally possible to check whether the number of predefined events having occurred to which the vehicle function has been assigned and which have been counted by the corresponding event counter corresponds to the actual number of predefined events having occurred. That will make it possible to check using simple means whether the adjacence lists have been correctly adjusted.

According to a further embodiment, the control device will be restarted if the vehicle function has been incorrectly assigned to the predefined event via the first and/or second adjacence list. Incorrect assigning means in this context that the check performed on the number of predefined events having occurred to which the vehicle function has been assigned and which have been counted by the corresponding event counter went wrong. That makes it possible for the vehicle function to be assigned in a simple manner to the predefined event via the first and/or second adjacence list if a fault occurred only while the assignment was being determined and/or if the event counter has incorrectly registered the number of predefined events having occurred.

According to a further embodiment, the control device's fault will be classified as a predefined event having occurred if the vehicle function has been incorrectly assigned to the predefined event via the first and/or second adjacence list. That will make it possible to detect in a simple manner that the control device is not operating fault-free.

According to other various embodiments, in a method and a device for accessing the assignment rule of the motor vehicle's control device, the assignment rule comprises at least the assignment. At least one vehicle function of the motor vehicle is assigned to the at least one predefined event of the motor vehicle by the assignment via the at least one first adjacence list stored on the control device's memory device. A read-access function is started when the assignment rule is read-accessed. The read-access function determines the vehicle function's assignment to the predefined event via the first adjacence list. A check is carried out when the assignment rule is write-accessed to determine whether the vehicle function's assignment, requiring to be written, to the predefined event exists. If the vehicle function's assignment to the predefined event does not exist then a write-access function will be started which adjusts the first adjacence list as a function of the assignment requiring to be written. That will make it possible to access the assignment while the motor vehicle is operating.

According to a further embodiment, a condition parameter assigned to a predefined condition is determined when the assignment rule is read-accessed. The predefined condition has been assigned to the predefined event and to the vehicle function assigned to the predefined event in such a way that the assigned vehicle function will be started or blocked only if the predefined event fulfills the condition. The condition parameter has in particular been assigned to the vehicle function's assignment to the predefined event. The condition parameter is assigned to the vehicle function's corresponding assignment, requiring to be written, to the predefined event when the assignment rule is write-accessed. That will make it possible to in a simple manner rate the predefined event's occurrence with the condition and to start or block the vehicle function as a function of the rating.

According to a further embodiment, a length of the first and/or second adjacence list and/or a number of the adjacence lists is/are predefined during write accessing. That can contribute to saving memory space and propagation time.

According to a further embodiment, the assignments of a plurality of vehicle functions to in each case at least one of the predefined events are adjusted during write accessing. The adjacence lists are furthermore adjusted accordingly during the one instance of write accessing. That contributes to not unnecessarily loading a processor of the control device while the plurality of assignments are being adjusted.

According to a further embodiment, the vehicle function's determined assignment to the predefined event is written by the read-access function to the memory device as an array when the assignment rule is read-accessed. The array with the vehicle function's assignment to the predefined event is then read. The vehicle function's assignment, requiring to be written, to the predefined event is written to the memory device as an array when the assignment rule is write-accessed. A check is then carried out to determine whether the assignment requiring to be written exists as a function of the array. The write-access function is started that will adjust the first adjacence list as a function of the array if the vehicle function's assignment to the predefined event does not exist. That will enable the assignment rule to be accessed in a particularly simple manner.

According to a further embodiment, the assignment of a plurality of vehicle functions to the predefined event is written to the memory device in a manner distributed among a plurality of arrays. If the configuration program can read arrays only of a predefined size, that will enable a very copious assignment to be shown also in the form of a plurality of arrays so that the configuration program will be able to read the assignment.

According to a further embodiment, a regular check is carried out on expiration of a predefined second period of time to determine whether the array on the memory device has been updated. If the array has been updated then the array will be read and/or the adjacence lists adjusted as a function of the array. That can contribute to the control device's processor being loaded to its predefined capacity.

The embodiments of the methods are readily transferable to embodiments of the devices for implementing the methods.

According to another embodiment, a computer-program product that includes a computer-readable medium may have program instructions that can be executed by a computer and are embodied for producing at least one adjacence list as a function of a matrix. Row values of the matrix are representative of at least the motor vehicle's predefined event or of at least the motor vehicle's predefined vehicle function. The column values of the matrix are representative of at least the predefined vehicle function or, as the case may be, of at least the predefined event.

The vehicle function has been assigned to the predefined event by the matrix. That will enable a person configuring the control device to perform the assignment in a clear and simple manner using the matrix and nonetheless be able thereafter to store the favorable representation of the adjacence list on the control device's memory device. That will contribute to a low space requirement in the memory device of the motor vehicle's control device. It will furthermore contribute to fast accessing when the assignment is being determined.

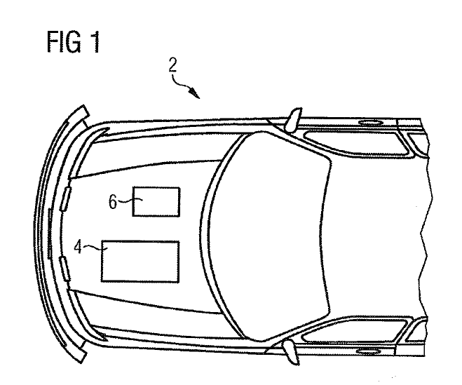

A motor vehicle 2 (FIG. 1) includes an internal-combustion engine 4 and a control device 6. The control device 6 can be designated also as a device for operating the motor vehicle 2. The control device 6 can furthermore be designated as a device for accessing an assignment rule. The control device 6 can include a plurality of control units.

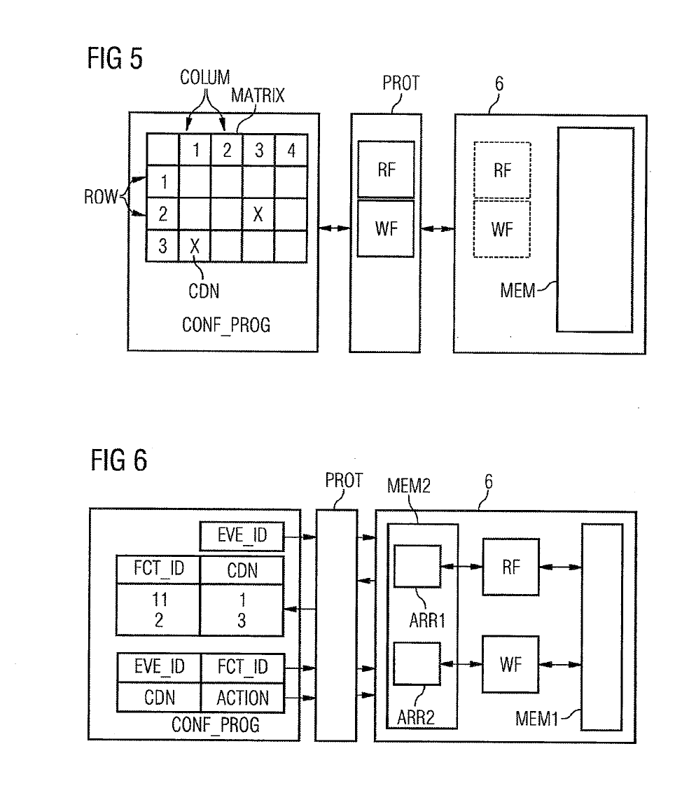

A memory device MEM of the control device 6 includes preferably a plurality of memory media MEM1, MEM2 (FIG. 5, FIG. 6). The memory device 6 further includes a main memory. In particular preferably each control unit includes, where applicable, the memory media MEM1, MEM2 and main memory.

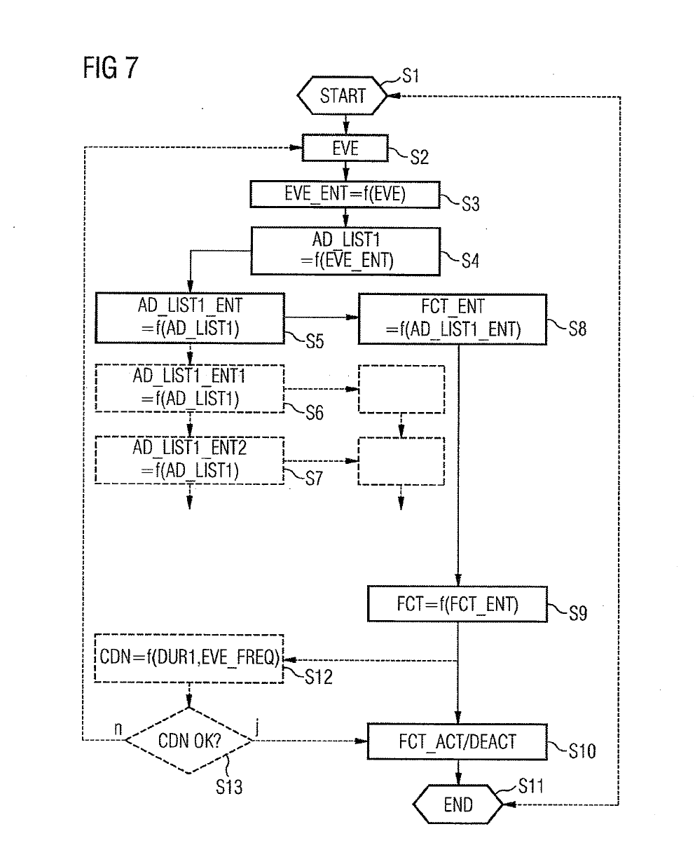

The control device 6 serves to start ACT or block DEACT a vehicle function FCT when a predefined event EVE (FIG. 7) occurs. The vehicle function FCT has been assigned to the predefined event EVE via an assignment rule. The predefined event EVE can be, for instance, a fault event of the motor vehicle 2. The vehicle function FCT can be, for example, an emergency-operation mode, a diagnostic strategy, and/or a substitute-value calculation that is started ACT or, as the case may be, blocked DEACT. For example, when a faulty component is detected a warning lamp assigned to the component can be activated. An exhaust-gas probe of the internal-combustion engine 4 can furthermore be deactivated for examining emissions from the internal-combustion engine 4, for instance.

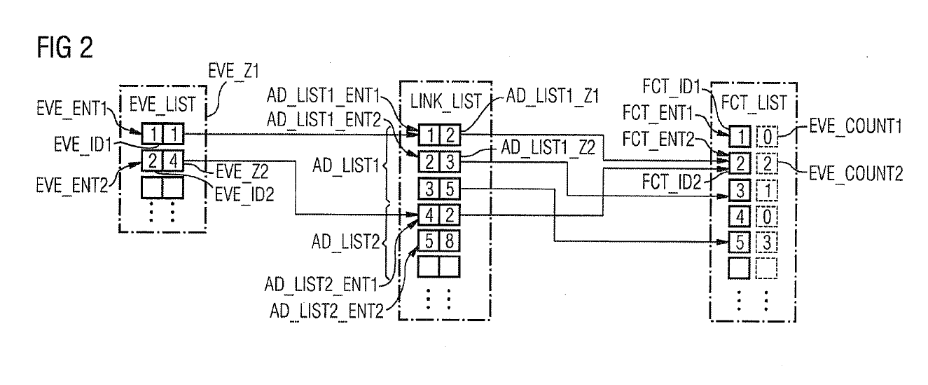

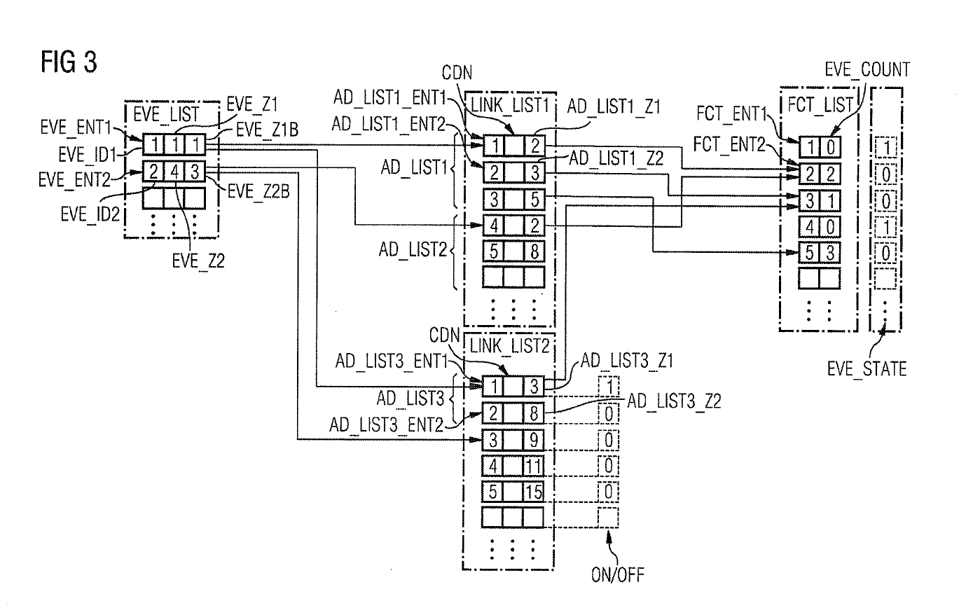

The assignment rule comprises at least one assignment LINK but preferably a plurality thereof. The assignment LINK assigns the vehicle function FCT to the corresponding predefined event EVE. The assignment LINK is made via at least one adjacence list but preferably a plurality thereof AD_LIST1, AD_LIST2, AD_LIST3 (FIG. 2, FIG. 3).

For example a first or second event entry EVE_ENT1, EVE_ENT2 in an event list EVE_LIST is determined (FIG. 2) as a function of the predefined event EVE. The first or, as the case may be, second event entry EVE_ENT1, EVE_ENT2 includes preferably a first or, as the case may be, second event identifier EVE_ID1, EVE_ID2 each uniquely assigned to one of the predefined events EVE. The first or, as the case may be, second event entry EVE_ENT1, EVE_ENT2 further includes a first or, as the case may be, second event pointer EVE_Z1, EVE_Z2 pointing to the first or, as the case may be, second adjacence list AD_LIST1, AD_LIST2. The event pointers EVE_Z1, EVE_Z2 point in particular to the start of the first or, as the case may be, second adjacence list AD_LIST1, AD_LIST2.

The first adjacence list AD_LIST1 contains any number of adjacence-list entries AD_LIST1_ENT1, AD_LIST_ENT2. The first and second adjacence list AD_LIST1, AD_LIST2 are combined in a link list LINK_LIST. The first and second adjacence-list entry AD_LIST1_ENT1, AD_LIST1_ENT2 in the first adjacence list AD_LIST1 include preferably the position of the corresponding adjacence-list entry AD_LIST1_ENT1, AD_LIST1_ENT2 in the link list LINK_LIST and a first or, as the case may be, second adjacence-list pointer AD_LIST1_Z1, AD_LIST1_Z2. The first and second adjacence-list pointer AD_LIST1_Z1, AD_LIST1_Z2 point to a first or, as the case may be, second vehicle-function entry FCT_ENT1, FCT_ENT2. The first event entry EVE_ENT1 has thus been assigned the first vehicle-function entry FCT_ENT1 via the first adjacence list AD_LIST1, in particular via the first adjacence-list entry AD_LIST1_ENT1 in the first adjacence list AD_LIST1. The vehicle-function entries FCT_ENT1, FCT_ENT2 are part of a vehicle-function list FCT_LIST and are preferably numbered end-to-end within the vehicle-function list FCT_LIST. The positions of the vehicle-function entries FCT_ENT1, FCT_ENT2 in the vehicle-function list FCT_LIST can be predefined by, for example, vehicle-function identifiers FCTID1, FCTID2 uniquely assigned to the corresponding vehicle function FCT. Preferably each vehicle-function entry FCT_ENT1, FCT_ENT2 has preferably been assigned an event counter that counts first and second numbers EVE_COUNT1, EVE_COUNT2 of events EVE having occurred that have been assigned to the corresponding vehicle-function entry FCT_ENT1, FCT_ENT2 and are the current events having occurred. The first or, as the case may be, second number EVE_COUNT1, EVE_COUNT2 of events EVE having occurred have preferably been stored in the main memory of the memory device MEM.

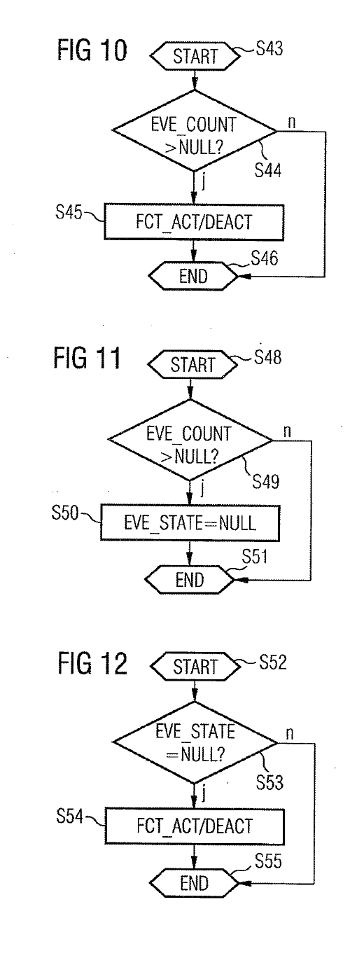

To check which vehicle function FCT is to be started ACT or blocked DEACT it is then necessary only to check whether the corresponding first or, as the case may be, second number EVE_COUNT1, EVE_COUNT2 is greater than zero NULL (FIG. 10).

In addition to the first and second event pointer EVE_Z1, EVE_Z2 the first or, as the case may be, second event entry EVE_ENT1, EVE_ENT2 can include a first or, as the case may be, second supplementary event pointer EVE_Z1B, EVE_Z2B (FIG. 3). The first and second supplementary event pointer EVE_Z1, EVE_Z2B point to the third or, as the case may be, a fourth adjacence list AD_LIST3. The third adjacence list AD_LIST3 includes a first and second adjacence-list entry AD_LIST3_ENT1, AD_LIST3_ENT2 in the third adjacence list AD_LIST3. The third and/or fourth adjacence list AD_LIST3 can be, for example, elements of a second link list LINK_LIST2. The link list LINK_LIST is then preferably designated as a first link list LINK_LIST1. For example the adjacence lists AD_LIST3 of the second link list LINK_LIST2 can be stored on the memory device MEM in such a way that they cannot be changed. That will make it possible for just one part of the assignment rule to be adjustable and thereafter the original settings to be restorable in a simple and convenient manner.

It will for that purpose be advantageous for the adjacence-list entries AD_LIST3_ENT1, AD_LIST3_ENT2 in the third adjacence list AD_LIST3 to have been assigned on/off values ON/OFF. Through specifying the on/off values ON/OFF it will then be possible to switch the respective assignment LINK on or off via the third adjacence list AD_LIST3. For example a bit equaling one can be set in a memory area of the memory device MEM, in which the on/off values ON/OFF are stored, for the first adjacence-list entry AD_LIST3_ENT1 in the third adjacence list AD_LIST3 if the assignment LINK of the vehicle function FCT to the predefined event EVE is to take place via the third adjacence list AD_LIST3.

The first and second adjacence-list entry AD_LIST3_ENT1, AD_LIST3_ENT2 in the third adjacence list AD_LIST3 include a first or, as the case may be, second adjacence-list pointer AD_LIST3_Z1, AD_LIST3_Z2 of the third adjacence list AD_LIST3 that each point to the corresponding vehicle-function entries FCT_ENT1, FCT_ENT2.

The adjacence-list entries AD_LIST1_ENT, AD_LIST1_ENT1, AD_LIST1_ENT2, AD_LIST3_ENT, AD_LIST3_ENT1, AD_LIST3_ENT2 and/or the adjacence-list entries AD_LIST2_ENT, AD_LIST2_ENT1, AD_LIST2_ENT2 preferably each include a mask representing a condition CDN. The condition CDN is preferably predefined by at least one condition parameter. The condition CDN serves to insure that the vehicle function FCT will only be assigned to the predefined event EVE as an occurred predefined event EVE if the condition CDN has been fulfilled. For example the predefined event EVE cannot be classified as having occurred unless it occurred, for example, during a first period of time DUR1 (FIG. 7) and/or unless it occurred with a predefined frequency EVE_FREQ and/or unless it occurred during a current traveling cycle of the motor vehicle. The condition parameter referred to the first period of time DUR1 is, for example, the length of the first period of time DUR1.

A list of status values EVE_STATE is furthermore preferably assigned to the vehicle-function list FCT_LIST. In particular the status values EVE_STATE are assigned to the vehicle-function entries FCT_ENT1, FCT_ENT2. For example the corresponding status value EVE_STATE zero NULL can be set as soon as the number EVE_COUNT of predefined events EVE having occurred is greater than zero NULL (FIG. 11). To check which vehicle function FCT has been activated ACT or deactivated DEACT it is then necessary only to check the corresponding supplementary value EVE_STATE (FIG. 12). That will be especially advantageous in particular if the list of status values EVE_STATE has been filed on the main memory of the memory device MEM of the control unit 6. It will then be possible to access the status values EVE_STATE very quickly and hence to decide very quickly which vehicle function FCT has to be started ACT or blocked DEACT.

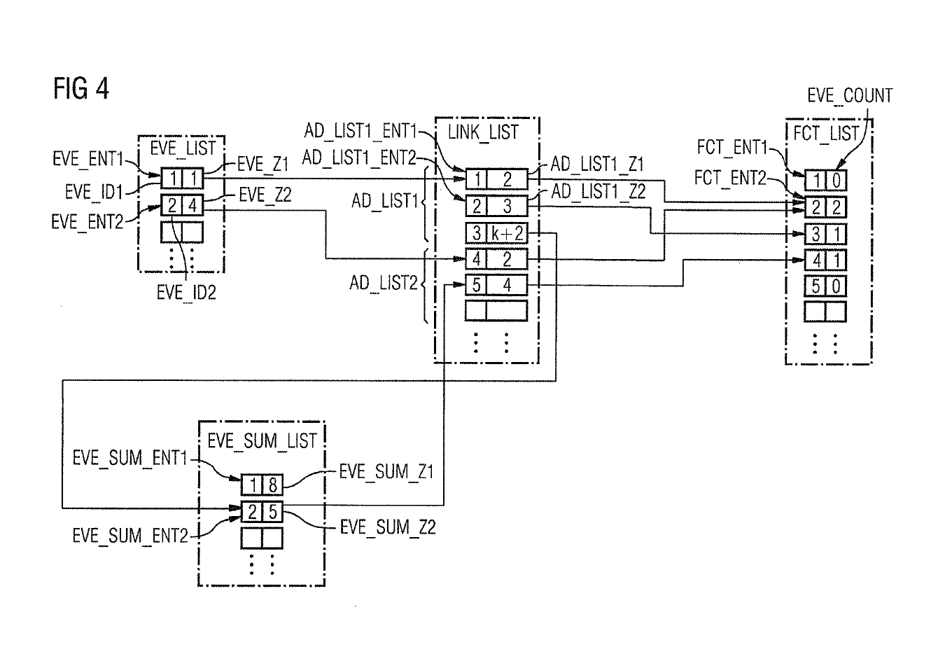

It is alternatively or additionally possible to predefine an event set (FIG. 4) comprising a plurality of predefined events EVE. For example it will not be possible to activate ACT or deactivate DEACT the vehicle function FCT unless each predefined event EVE in the event set has occurred. That can be realized by, for example, creating an event-set list EVE_SUM_LIST. The event-set list EVE_SUM_LIST comprises at least one event-set entry but preferably a plurality thereof EVE_SUM_ENT, EVE_SUM_ENT1, EVE_SUM_ENT2.

The first and second event-set entry EVE_SUM_ENT1, EVE_SUM_ENT2 each include an event-set pointer EVE_SUM_Z1, EVE_SUM_Z2. The second event-set pointer EVE_SUM_Z2 points to the start of the second adjacence list AD_LIST2. The correct event-set entry EVE_SUM_ENT1, EVE_SUM_ENT2 to which the predefined event EVE having occurred has been assigned can be found by, for example, giving the corresponding adjacence-list pointer AD_LIST1_Z1, AD_LIST1_Z2 of the first adjacence list AD_LIST1 a value greater than the maximum number k of vehicle-function entries FCT_ENT1, FCT_ENT2. The adjacence-list pointer AD_LIST1_Z1, AD_LIST1_Z2 will hence point to a memory area in the memory device MEM outside the memory area in which the vehicle-function entries FCT_ENT1, FCT_ENT2 have been filed; the predefined event EVE will thus be assigned to the event-set list EVE_SUM_LIST and the value of the adjacence-list pointer AD_LIST1_Z1, AD_LIST1_Z2 of the first adjacence list AD_LIST1 will be decremented by the number k of vehicle-function entries FCT_ENT1, FCT_ENT2 and assigned to the event-set entry EVE_SUM_ENT1, EVE_SUM_ENT2 at the corresponding position in the event-set list EVE_SUM_LIST. The corresponding vehicle function FCT will then be started ACT or blocked DEACT as a function of the event-set entry EVE_SUM_ENT1, EVE_SUM_ENT2. The predefined event EVE will thus have been assigned the vehicle function FCT via the event set that includes the predefined event EVE.

A configuration program CONF_PROG is preferably used for accessing the assignment rule (FIG. 5). The configuration program CONF_PROG is suitable for reading arrays ARR in predefined memory areas of the memory device MEM and writing them to predefined memory areas of the memory device MEM. A matrix MATRIX is for that purpose conveyed to the configuration program CONF_PROG preferably before the assignment rule is accessed. Array ARR means in this context that the data of the array ARR is of a uniform data type and stored in the memory device MEM in such a way that the array ARR can be accessed via an index.

The matrix MATRIX has column values COLUMN and row values ROW. The row values ROW can, for example, be representative of the predefined events EVE. The column values COLUMN will then have been assigned to the vehicle functions FCT. The assignment LINK of the vehicle function FCT to the predefined event EVE can simply be identified as a crossover in the corresponding field in the matrix MATRIX. However, the condition CDN, in particular the condition parameter, is preferably entered in the field representing the assignment LINK.

The assignments LINK represented by the entries in the matrix MATRIX are really stored in the memory device MEM. The blank fields in the matrix MATRIX are stored really only in a memory medium in which the configuration program CONF_PROG has been stored though not on a real memory area of the memory device MEM.

The configuration program CONF_PROG communicates with the control device 6 via a protocol PROT. For reading the assignment LINK a corresponding event identifier EVE_ID is sent by the configuration program CONF_PROG to the control device 6 via the protocol PROT. A read-access function RF is preferably started for reading the determined assignment LINK from the memory device MEM. The read-access function RF serves to determine the corresponding assignment LINK of the vehicle function FCT to the predefined event EVE using the adjacence lists AD_LIST1, AD_LIST2, AD_LIST3 and to send it to the configuration program CONF_PROG via the protocol PROT in such a way that the configuration program CONF_PROG will be able to read the corresponding assignment LINK.

The corresponding assignment LINK requiring to be written is entered in the matrix MATRIX when the assignment rule is write-accessed. The assignment LINK requiring to be written means that the assignment LINK is to be created or changed. The configuration program CONF_PROG sends the corresponding assignment LINK to the control device 6 via the protocol PROT. A check is therein first carried out to determine whether the assignment LINK, requiring to be written, of the vehicle function FCT already exists EXIST for the corresponding predefined event EVE. The write access will be terminated if the assignment LINK already exists EXIST. If the assignment LINK does not exist, a write-access function WF will adjust the corresponding adjacence lists AD_LIST1, AD_LIST2 in accordance with the new assignment LINK. The effect of that is that the configuration program CONF_PROG will be unable to tell which assignments LINK of the assignment rule have actually been filed in a real memory area of the memory device MEM. In contrast thereto, only the actually present assignments LINK of the vehicle functions FCT to the predefined events EVE will have been filed in the real memory area MEM. The fields in the matrix MATRIX in which there are no matrix entries will accordingly only have been filed in a virtual memory area of the control device 6.

The write-access function WF and/or read-access function RF is/are implemented in a code stored in the memory device MEM. Separate codes can alternatively have been filed in the memory device MEM for the write-access function WF and/or read-access function RF. The write-access function WF and/or read-access function RF can furthermore be implemented in a code for processing the protocol PROT.

For example the event identifier EVE_ID (FIG. 6) can be sent by the configuration program CONF_PROG to the control device 6 via the protocol PROT when the assignment rule is read-accessed. Using the event identifier EVE_ID, the control device 6 determines the corresponding vehicle function FCT by means of the read-access function RF via the adjacence lists AD_LIST1, AD_LIST2, AD_LIST3, which are preferably stored on the non-volatile first memory medium MEM1 of the memory device MEM. The read-access function RF can, for example, file the assignment LINK on a second memory medium MEM2 of the memory device MEM in the form of a first array ARR1. The first array ARR1 can then be read in a simple manner by the configuration program CONF_PROG. The configuration program CONF_PROG is hence able to represent a corresponding function identifier FCT_ID and, where applicable, the condition CDN associated therewith in a simple manner.

Furthermore, for example when the assignment rule is being write-accessed the corresponding event identifier EVE_ID, the vehicle function FCT requiring to be assigned via the corresponding vehicle-function identifier FCT_ID, and/or the associated condition CDN and an action ACTION that is to be performed can be entered in the configuration program CONF_PROG. That entire assignment LINK is sent by the configuration program CONF_PROG via the protocol PROT to the control device 6. Said assignment LINK is there filed on the second memory medium MEM2 in the form of a second array ARR2. A regular check is preferably carried out on expiration of a second period of time DUR2 (FIG. 18) to determine whether the first and/or second array ARR1, ARR2 has/have been updated. If the arrays ARR1, ARR2 have been updated then the read-access function RF or, as the case may be, write-access function WF will be started accordingly. The write-access function WF adjusts the adjacence lists AD_LIST1, AD_LIST2, AD_LIST3 in keeping with the current second array ARR2.

The first memory medium MEM1 is preferably supplied by a manufacturer of the control device 6 to an automobile manufacturer in such a form that the data structure, in particular the third adjacence list AD_LIST3 which is filed on the first memory medium MEM1, cannot be changed. The second memory medium MEM2 is preferably designed such that the automobile manufacturer will be able to change the data structure on the second memory medium MEM2. Before the motor vehicle 2 is delivered to the end customer or a dealer the second memory medium MEM2 will then also be embodied such that the data structure and its data can no longer be changed on the second memory medium MEM2.

A first program (FIG. 7) for operating the motor vehicle 2 has preferably been stored on the memory device MEM. The first program serves to determine the vehicle function FCT assigned to the predefined event EVE. The first program serves further to start ACT or block DEACT the determined vehicle function FCT. The first program is started preferably soon after the motor vehicle 2 has been started, in particular when the internal-combustion engine 4 and/or the control device 6 is/are started at a step S1. Variables are, where applicable, initialized at step S1.

The predefined event EVE is determined at a step S2. The predefined event EVE can be registered by, for example, a sensor of the internal-combustion engine 4.

An event entry EVE_ENT assigned to the predefined event EVE is determined at a step S3 as a function of the predefined event EVE. The event entry EVE_ENT can be determined via, for example, the event identifier EVE_ID.

The first adjacence list AD_LIST1 assigned to the determined event entry EVE_ENT is determined at a step S4 as a function of the event entry EVE_ENT. The first adjacence list AD_LIST1 is preferably determined using the event pointer EVE_Z1, EVE_Z2 that points to a start of the first adjacence list AD_LIST1.

An adjacence-list entry AD_LIST1_ENT in the first adjacence list AD_LIST1 is determined at a step S5 as a function of the first adjacence list AD_LIST1. All adjacence-list entries AD_LIST1_ENT, AD_LIST1_ENT1, AD_LIST1_ENT2 in the first adjacence list AD_LIST1 are processed at steps S6 and S7 and, where applicable, at further steps.

A vehicle-function entry FCT_ENT assigned to the adjacence-list entry AD_LIST1_ENT in the first adjacence list AD_LIST1 is determined at a step S8 as a function of the adjacence-list entry AD_LIST1_ENT in the first adjacence list AD_LIST1. Alternatively to the vehicle-function entry FCT_ENT it is possible also for just the vehicle-function identifier FCT_ID to be determined, which will then have been assigned to the adjacence-list entry AD_LIST1_ENT in the first adjacence list AD_LIST1. The vehicle-function entry FCT_ENT is preferably determined by means of the adjacence-list pointer AD_LIST_Z1, AD_LIST1_Z2 of the first adjacence list AD_LIST1 pointing to the vehicle-function entry FCT_ENT or, as the case may be, to the corresponding vehicle-function identifier FCT_ID.

The vehicle function FCT for the vehicle-function entry FCT_ENT is determined at a step S9. That can be done using, for example, the vehicle-function list FCT_LIST in which the vehicle function FCT has been assigned the corresponding vehicle-function entry FCT_ENT or, as the case may be, corresponding vehicle-function identifier FCT_ID.

The determined vehicle function FCT is started ACT or blocked DEACT at a step S10. Alternatively to step S10 it is possible also for processing to initially continue at a step S12.

The condition CDN that has been assigned to the predefined event EVE and as a function of which the predefined event EVE can be classified as having occurred is determined at step S12. The condition CDN is determined preferably as a function of the first period of time DUR1 and of the frequency EVE_FREQ with which the predefined event EVE occurred.

A check is carried out at a step S13 to determine whether the condition CDN has been fulfilled OK. If the condition of step S13 has been fulfilled OK then the program will continue at step S10. If the condition CDN of step S13 has not been fulfilled then processing will continue at step S2.

The first program can be terminated at a step S11.

The first program can alternatively have been implemented in a program of the control device 6 in such a way that the first program will be executed for all predefined events EVE shortly after the motor vehicle 2, particularly the internal-combustion engine 4 of the motor vehicle 2, starts. It can in that was be insured that the number EVE_COUNT of predefined events EVE will also be correct if the predefined event EVE already exists when the motor vehicle 2 starts.

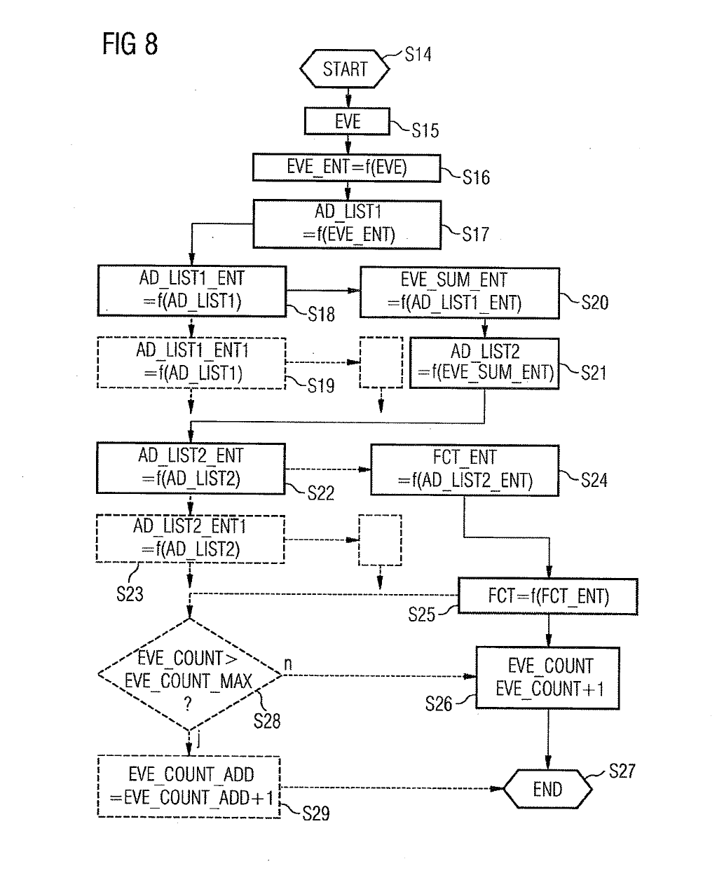

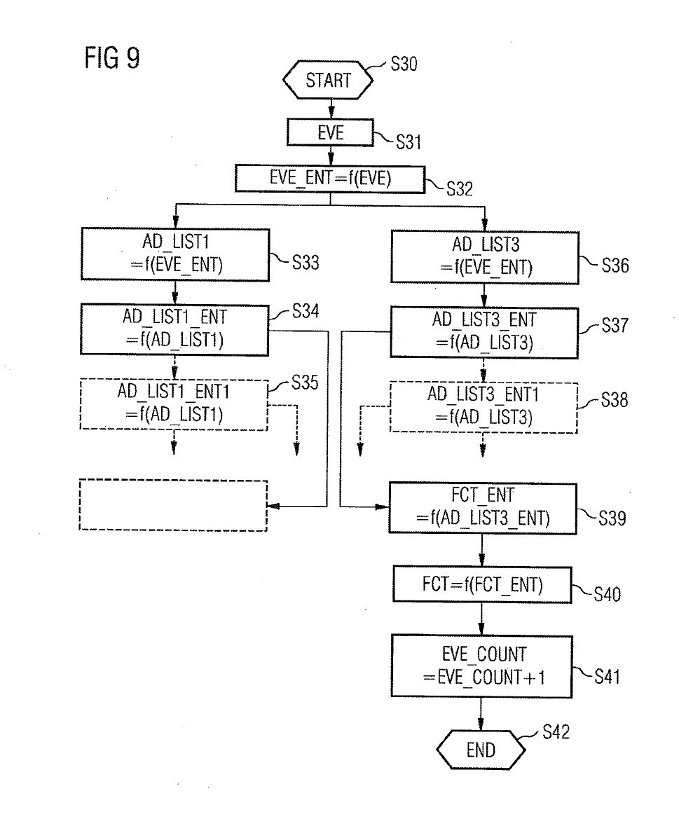

A second program (FIG. 8) can alternatively or additionally have been stored in the memory device MEM of the control unit 6. The second program serves to assign the predefined event EVE to the predefined event set and to assign the predefined event set to the corresponding vehicle function FCT. The second program is executed at steps S14 to S19 analogously to steps S1 to S6 of the first program.

The event-set entry EVE_SUM_ENT assigned to the adjacence-list entry AD_LIST1_ENT in the first adjacence list AD_LIST1 is determined at a step S20 as a function of the adjacence-list entry AD_LIST1_ENT in the first adjacence list AD_LIST1, preferably by means of the adjacence-list pointer AD_LIST1_Z1, AD_LIST1_Z2 of the first adjacence list AD_LIST1 pointing to the corresponding event-set entry EVE_SUM_ENT.

The second adjacence list AD_LIST2 assigned to the corresponding event-set entry EVE_SUM_ENT is determined at a step S21 as a function of the event-set entry EVE_SUM_ENT, preferably by means of the event-set pointer EVE_SUM_Z1, EVE_SUM_Z2 of the event-set list EVE_SUM_LIST that points to a start of the second adjacence list AD_LIST2.

The adjacence-list entry AD_LIST2_ENT in the second adjacence list AD_LIST2 is determined at a step S22 as a function of the second adjacence list AD_LIST2 analogously to step S18. Further adjacence-list entries AD_LIST2_ENT in the second adjacence list AD_LIST_2 that are encompassed by the second adjacence list AD_LIST_2 are determined at a step S23 and, where applicable, at further steps.

The second adjacence list AD_LIST2 of the vehicle-function entry FCT_ENT assigned to the adjacence-list entry AD_LIST2_ENT in the second adjacence list AD_LIST2 is determined at a step S24 as a function of the adjacence-list entry AD_LIST2_ENT.

The vehicle function FCT is determined at a step S25 analogously to step S9 of the first program.

The number EVE_COUNT, registered by the event counter, of events EVE having occurred assigned the vehicle function FCT is adjusted at a step S26, preferably by incrementing the number EVE_COUNT of predefined events EVE having occurred by one unit.

The second program can be terminated at a step S27.

Processing of the second program can alternatively also continue after step S25 at a step S28. A check is carried out at step S28 to determine whether the number EVE_COUNT of predefined events EVE having occurred is greater than a maximum number EVE_COUNT_MAX of events EVE having occurred which the event counter is able to count. If the condition of step S28 has not been fulfilled then processing will continue at step S26. If the condition of step S28 has been fulfilled it means the corresponding event counter is unable to count any further predefined events EVE. That is why processing will continue at a step S29.

An auxiliary event counter EVE_COUNT ADD is started and adjusted at step S29, preferably by being incremented by one unit. The second program can then be terminated at step S27. For example if the condition of step S28 has been fulfilled then the number EVE_COUNT of predefined events EVE having occurred can be deducted from the maximum number EVE_COUNT_MAX of events EVE having occurred and the result can be used as the index of the corresponding auxiliary event counter EVE_COUNT_ADD, with the corresponding auxiliary event counter EVE_COUNT_ADD having been uniquely established via the index.

A third program (FIG. 8) for operating the motor vehicle 2 can alternatively or additionally have been stored in the control device 6. The third program serves analogously to the first program to determine the vehicle function FCT as a function of the event EVE having occurred. Steps S30 to S35 of the third program are processed analogously to steps S1 to S6 of the first program.

A start of the third adjacence list AD_LIST3 assigned to the event entry EVE_ENT is determined at a step S36 as a function of the event entry EVE_ENT.

An adjacence-list entry AD_LIST3_ENT, encompassed by the third adjacence list AD_LIST3, in the third adjacence list AD_LIST3 is determined at a step S37 as a function of the third adjacence list AD_LIST3. The other adjacence-list entries AD_LIST3_ENT1, AD_LIST3_ENT2 in the third adjacence list AD_LIST3 are determined analogously at a step S38 and, where applicable, at further steps.

The vehicle-function entry FCT_ENT is determined at a step S39 analogously to step S8 of the first program.

The vehicle function FCT is determined at a step S40 analogously to step S9 of the first program.

The number EVE_COUNT of events EVE having occurred is adjusted at a step S41 analogously to step S26 of the second program.

The third program can be terminated at a step S42 analogously to step S11 of the first program.

A fourth program (FIG. 10) for starting ACT or blocking DEACT the vehicle function FCT is preferably stored on the memory device MEM. The fourth program serves to activate ACT or deactivate DEACT the vehicle function FCT as a function of the number EVE_COUNT of predefined events EVE having occurred. The fourth program is started at a step S43 analogously to step S1 of the first program.

A check is carried out at a step S44 to determine whether the number EVE_COUNT of predefined events EVE that have occurred is greater than zero NULL.

If the condition of step S44 has not been fulfilled then the fourth program can be terminated at a step S46. If the condition of step S44 has been fulfilled then processing will continue at a step S45.

The vehicle function FCT is started ACT or blocked DEACT at step S45 analogously to step S9 of the first program.

The fourth program can be terminated at step S46. The fourth program will, though, preferably be restarted and hence preferably all vehicle functions FCT, in particular the corresponding numbers EVE_COUNT of predefined events EVE having occurred, checked.

A fifth program (FIG. 11) has preferably been stored on the memory device MEM of the control device 6. The fifth program serves to set the status value EVE_STATE. The fifth program is started at a step S48 analogously to step S1 of the first program.

A check is carried out at a step S49 to determine whether the number EVE_COUNT of predefined events EVE that have occurred is greater than zero NULL. If the condition of step S49 has not been fulfilled then the fifth program can be terminated at a step S51. If the condition of step S49 has been fulfilled then processing will continue at a step S50.

The status value EVE_STATE assigned to the corresponding event counter is set to zero NULL at step S50. The fifth program can be terminated at a step S51. The fifth program will, though, preferably be restarted analogously to the fourth program and hence preferably all status values EVE_STATE of the vehicle functions FCT adjusted.

Based on the fifth program it can then ensuingly be very easily and very quickly checked whether the vehicle function FCT has to be started ACT or blocked DEACT.

A sixth program (FIG. 12) has preferably been stored on the memory device MEM of the motor vehicle 2. The sixth program serves analogously to the fourth program to start ACT or block DEACT the vehicle function FCT. The sixth program is started at a step S52 analogously to step S1 of the first program.

A check is carried out at a step S53 to determine whether the status value EVE_STATE is zero. If the condition of step S35 has not been fulfilled then the sixth program can be terminated at a step S55. If the condition of step S53 has been fulfilled then processing will continue at a step S54.

The vehicle function FCT is started ACT or blocked DEACT at step S54 analogously to step S45 of the fourth program.

The sixth program can be terminated at a step S55. The sixth program will, though, preferably be re-executed analogously to the fourth and fifth program for preferably all status values EVE_STATE of all vehicle functions FCT.

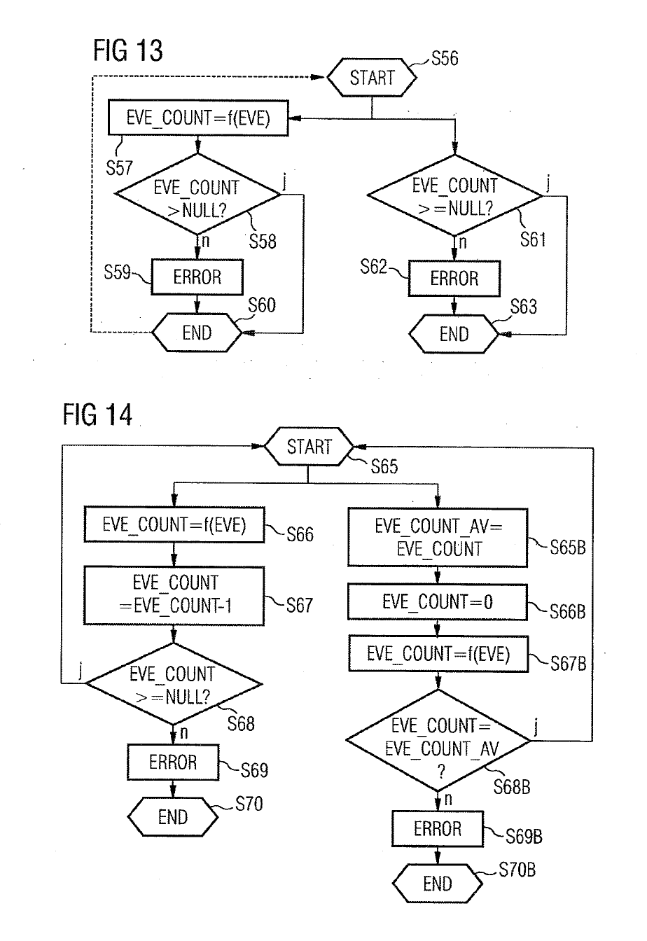

A seventh program (FIG. 13) has preferably been stored on the memory device MEM. The seventh program serves to check whether the vehicle functions FCT have been correctly assigned to the corresponding predefined event EVE. The seventh program is started at a step S56 analogously to step S1 of the first program.

The number EVE_COUNT of predefined events EVE is determined at a step S57. A check is carried out at a step S58 to determine whether the number EVE_COUNT of corresponding predefined events EVE having occurred is greater than zero NULL. If the condition of step S58 has been fulfilled then the seventh program can be terminated at a step S60. If the condition of step S58 has not been fulfilled then processing will continue at a step S59.

An error message ERROR is generated at step S59 and preferably filed in an error memory of the memory device MEM. The control device 6 can alternatively or additionally be restarted as a function of the error message ERROR and/or, where applicable, the predefined event EVE relating to the faulty control device 6 can be classified as having occurred.

The seventh program can be terminated at step S60. The seventh program will, though, preferably be resumed at step S56 so that all numbers EVE_COUNT of predefined events EVE having occurred can be checked. Processing can alternatively or additionally also continue after step S56 at a step S61.

A check is carried out at step S61 to determine whether the number EVE_COUNT of predefined events having occurred is greater than or equal to zero NULL. If the condition of step S61 has been fulfilled then the seventh program can be terminated at a step S63. If the condition of step S61 has not been fulfilled then processing will continue at a step S62.

The error message ERROR is generated at step S62 analogously to step S59.

An eighth program can alternatively or additionally have been stored in the memory device MEM (FIG. 14). The eighth program serves analogously to the seventh program to check whether the assignment LINK of the vehicle function FCT to the predefined event EVE is correct. The eighth program is started at a step S65 analogously to step S1 of the first program.

The number EVE_COUNT of predefined events EVE having occurred is determined at a step S66 analogously to step S57 of the seventh program.

The number EVE_COUNT of predefined events EVE having occurred is decremented by one unit at a step S67.

A check is carried out at a step S68 to determine whether the number EVE_COUNT of predefined events having occurred is greater than or equal to zero NULL. If the condition of step S68 has not been fulfilled then the error message ERROR will be generated at a step S69 analogously to step S59 of the seventh program. If the condition of step S68 has been fulfilled then the eighth program will be restarted, with a predefined event EVE different from that when the eighth program was previously executed being checked the next time the eighth program is executed.

The eighth program will preferably not be terminated at a step S70 until all numbers EVE_COUNT of predefined events EVE having occurred have been checked. That will make it easy to check whether all predefined events EVE have been correctly detected while the motor vehicle 2 has been operating and the assigned vehicle functions FCT have been started ACT or blocked DEACT accordingly.

Alternatively or additionally to step S66 the eighth program can continue at a step S65B at which the number EVE_COUNT of predefined events EVE having occurred is assigned a current number EVE_COUNT_AV of predefined events EVE having occurred.

The number EVE_COUNT of predefined events EVE having occurred is set to zero at a step S66B.

The number EVE_COUNT of predefined events EVE having occurred is determined at a step S67B analogously to step S57 of the seventh program.

A check is carried out at a step S68B to determine whether the number EVE_COUNT of predefined events EVE having occurred corresponds to the current number EVE_COUNT_AV of predefined events EVE having occurred. If the condition of step S68B has been fulfilled then the eighth program will preferably be restarted, with another number EVE_COUNT of an occurred predefined event EVE different from that when the eighth program was previously executed then being checked. If the condition of step S68B has not been fulfilled then the error message ERROR will be generated at a step S69B analogously to step S69.

The eighth program will preferably not be terminated at a step S70B until all numbers EVE_COUNT of predefined events EVE having occurred have been checked.

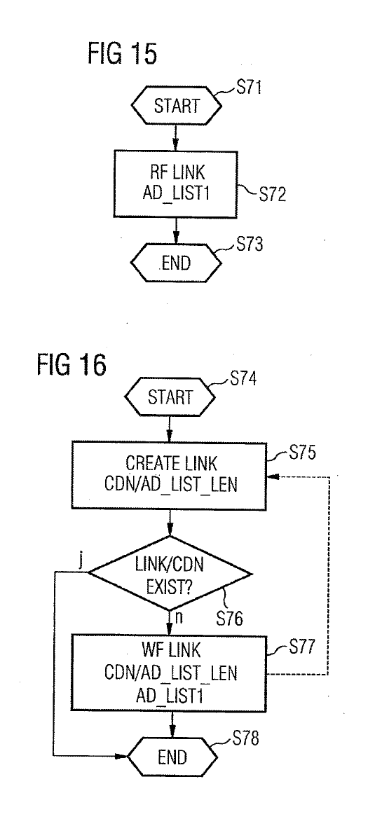

A ninth program (FIG. 15) has preferably been stored on the memory device MEM for read-accessing for accessing the assignment rule. The ninth program serves to read the assignment LINK of the assignment rule. The ninth program is started at a step S71 analogously to step S1 of the first program.

The read-access function RF is started at a step S72 for reading the assignment LINK of the vehicle function FCT to the predefined event EVE from the first adjacence list AD_LIST1.

The ninth program can be terminated at a step S73.

A tenth program (FIG. 16) has preferably been stored on the memory device MEM of the control unit 6 for write-accessing the assignment rule for writing the assignment LINK. The tenth program serves to store the assignment LINK of the vehicle function FCT to the predefined event EVE on the memory device MEM. The tenth program is started at a step S74 analogously to step S1 of the first program.

The assignment LINK of the vehicle function FCT to the predefined event EVE is created CREATE at a step S75. Create CREATE means in this context that, for example, a matrix entry corresponding to the assignment LINK is made in the matrix MATRIX in the configuration program CONF_PROG. The assignment LINK is, where applicable, preassigned the condition CDN and/or a length AD_LIST_LEN in the adjacence lists AD_LIST1, AD_LIST2.

A check is carried out at a step S76 to determine whether the assignment having, where applicable, the condition CDN exists EXIST. If the condition of step S76 has been fulfilled then the tenth program can be terminated at a step S78. If the condition of step S76 has not been fulfilled then processing will continue at a step S77.

The write-access function WF is started at step S77 for writing the assignment LINK into the first adjacence list AD_LIST1, where applicable, along with the condition CDN and/or length AD_LIST_LEN of the first or second adjacence list AD_LIST1, AD_LIST2.

If a plurality of assignments LINK are to be changed at the same time, then processing after step S77 can also continue again at step S75. However, when steps S75 to S77 are executed again an assignment LINK that is different from that during the previous execution will be written to the memory device MEM.

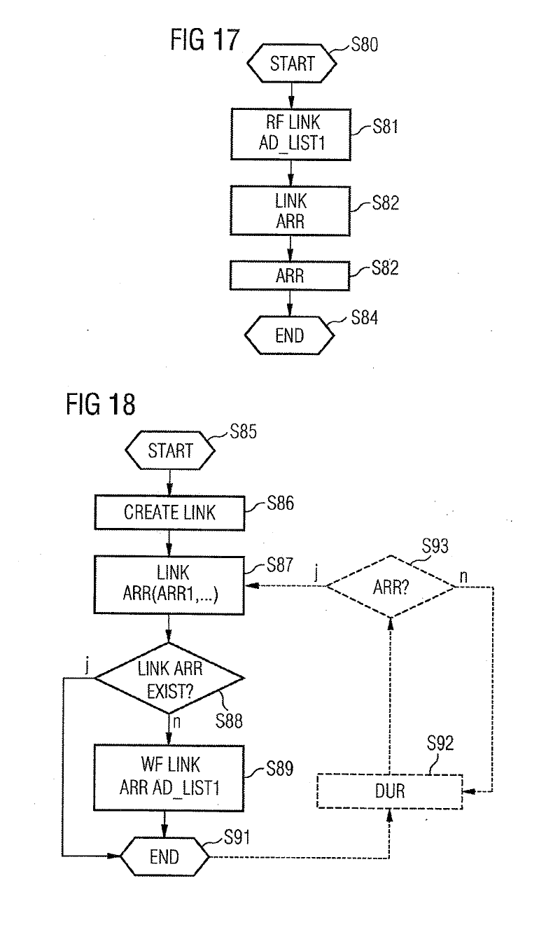

An eleventh program (FIG. 17) can alternatively have been stored on the memory device MEM for reading the assignment LINK. The eleventh program is started at a step S80 analogously to step S1 of the first program. The assignment of the vehicle function FCT to the predefined event EVE is read from FROM the first adjacence list AD_LIST1 at a step S81 analogously to step S72 of the ninth program.

The assignment LINK of the vehicle function FCT to the predefined event EVE is written to the second memory medium MEM2 as an array ARR at a step S82.

The array ARR can be read by the configuration program CONF_PROG at a step S83. The eleventh program can be terminated at a step S84.

A twelfth program (FIG. 18) can alternatively or additionally be stored on the memory device MEM for writing the assignment LINK. The twelfth program is started at a step S85 analogously to step S1 of the first program.

The assignment LINK of the vehicle function FCT to the predefined event EVE is created CREATE at a step S86.

The assignment LINK is written to the second memory medium MEM2 as an array ARR at a step S87. The assignment LINK can, where applicable, also be distributed among a plurality of arrays ARR1, ARR2.

A check is carried out at a step S88 to determine whether the assignment LINK of the array ARR exists EXIST. If the condition of step S88 has been fulfilled then the twelfth program can be terminated at a step S91. If the condition of step S88 has not been fulfilled then processing will continue at a step S89.

The first adjacence list AD_LIST1 is adjusted at step S89 as a function of the assignment LINK presented by the array ARR.

The twelfth program can be terminated at step S91. The twelfth program will, though, preferably keep being executed at regular intervals while the motor vehicle 2 is operating, for example on expiration of the second period of time DUR2.

A check can therein be carried out for example each time at a step S93, after a pause at step S92 for the predefined second period of time DUR2, to determine whether the array ARR has been re-stored on the second memory medium MEM2. If the condition of step S93 has not been fulfilled then processing will resume at step S92. If the condition of step S93 has been fulfilled then processing will continue at step S87.

The adjacence lists AD_LIST1, AD_LIST2, AD_LIST3 can alternatively be produced as a function of the matrix MATRIX (FIG. 5) by means of a computer-program product for producing the adjacence lists AD_LIST1, AD_LIST2, AD_LIST3. The computer-program product includes a computer-readable medium having program instructions that can be executed by a computer. The program instructions are embodied for producing at least the first adjacence list (AD_LINK1) as a function of the matrix MATRIX. The computer-program product can also include, for example, the configuration program CONF_PROG. The complete adjacence lists AD_LIST1, AD_LIST2, AD_LIST3 comprising the complete assignment rule will then preferably be sent by the configuration program CONF_PROG to the control device 6. The computer-program product will preferably be passed by the manufacturer of the control device 6 to the automobile manufacturer, in particular to the person configuring the control device.

The invention is not restricted to the embodiments described. For example all programs or a plurality thereof can be implemented in a main program. Individual programs only can furthermore also be differently implemented jointly. The programs can furthermore be divided into further subprograms. Programs can furthermore have been implemented in standard processes of the control device 6 and/or standard processes for executing the protocol PROT. An adjacence-list representation differing from that described can furthermore be selected. The first three adjacence-list representations can, moreover, be mutually combined.

What is claimed is:

1. A method for operating a motor vehicle comprising the steps of:
upon the occurrence of at least one predefined event of the motor vehicle:
determining an event entry assigned to the predefined event in an event list as a function of the predefined event,
determining a first adjacence list assigned to the determined event entry and comprising at least one adjacence-list entry as a function of the determined event entry,
determining a vehicle-function entry assigned to the corresponding adjacence-list entry in the first adjacence list and to the predefined vehicle function for each adjacence-list entry in the first adjacence list,
determining the predefined vehicle function as a function of the vehicle-function entry,
starting or blocking the determined vehicle function.

2. The method according to claim 1, wherein
an event-set entry assigned to the adjacence-list entry in the first adjacence list and to a predefined event set containing the predefined event and at least one further predefined event is determined as a function of the adjacence-list entry in the first adjacence list,
a second adjacence list assigned to the determined event-set entry and containing the at least one adjacence-list entry in the second adjacence list is determined as a function of the determined event set,
the vehicle-function entry assigned to the corresponding adjacence-list entry in the second adjacence list and to the corresponding vehicle function is determined for each adjacence-list entry in the second adjacence list.

3. The method according to claim 1, wherein
the first adjacence list is determined and also a third adjacence list, assigned to the determined event entry and containing at least one adjacence-list entry, as a function of the determined event entry,
a corresponding vehicle-function entry assigned to the adjacence-list entry in the first adjacence list or, as the case may be, to the adjacence-list entry in the third adjacence list is determined for each adjacence-list entry in the first adjacence list and for each adjacence-list entry in the third adjacence list, with the first adjacence list being able to be changed and the third adjacence list being unable to be changed.

4. The method according to claim 1, wherein
an event counter assigned to the vehicle-function entry and representative of a number of predefined events assigned to the determined function entry and having already occurred is adjusted for each determined vehicle-function entry,
the corresponding vehicle function will be started or, as the case may be, blocked if the number is greater than zero.

5. The method according to claim 4, wherein a status value assigned to the predefined vehicle function and to the corresponding event counter will be adjusted if the corresponding event counter is greater than zero and wherein the predefined vehicle function will be started or blocked as a function of the status value.

6. The method according to claim 1, wherein the predefined event will be classified as having occurred only if the predefined event having occurred fulfills at least one predefined condition.

7. The method according to claim 6, wherein the predefined event will be classified as having occurred only if the predefined event having occurred has occurred for a predefined first period of time.

8. The method according to claim 1, wherein the predefined event will be classified as having occurred only if the predefined event has occurred with a predefined frequency.

9. The method according to claim 4, wherein the number of predefined events having occurred which the event counter is able to count is limited by a maximum number and wherein an auxiliary event counter will be started if the number of predefined events for the corresponding vehicle function that have occurred is greater than the maximum number.

10. The method according to claim 4, wherein
a check is carried out on a predefined set of predefined events when a control device of the motor vehicle starts, in order to determine which is the current predefined event,
the vehicle function assigned to the current predefined event having occurred is determined,
the event counter assigned to the vehicle function is adjusted accordingly.

11. The method according to claim 4, wherein to determine whether the vehicle function has been correctly assigned to the predefined event via at least one of: the first and second adjacence list, a check is carried out by at least one of the following steps:
checking for the current predefined event having occurred whether the number of predefined events having occurred to which the vehicle function has been assigned and which have been counted by the corresponding event counter is greater than zero,
checking whether the number of predefined events having occurred to which the vehicle function has been assigned and which have been counted by the corresponding event counter is zero or greater than zero,
shortly before the motor vehicle motor vehicle is switched off, decrementing the corresponding event counter by one unit for each vehicle function per predefined event having occurred and checking whether the number of predefined events having occurred is zero after decrementing,
checking whether the number of predefined events having occurred to which the vehicle function (FCT) has been assigned and which have been counted by the corresponding event counter corresponds to the actual number of predefined events having occurred.

12. The method according to claim 11, wherein the control device will be restarted if the vehicle function has been incorrectly assigned to the predefined event via at least one of: the first and second adjacence list.

13. The method according to claim 1, wherein a fault in the control device will be classified as a predefined event having occurred if the vehicle function has been incorrectly assigned to the predefined event via at least one of: the first and second adjacence list.

14. A device for operating a motor vehicle, the device being operable, upon the occurrence of at least one predefined event of the motor vehicle,
to determine an event entry, assigned to the predefined event, in an event list as a function of the predefined event,
to determine a first adjacence list, assigned to the event entry and containing at least one adjacence-list entry, as a function of the determined event entry,
to determine a vehicle-function entry, assigned to the predefined vehicle function and to the corresponding adjacence-list entry in the first adjacence list, for each adjacence-list entry in the first adjacence list,
to determine the predefined vehicle function as a function of the vehicle-function entry, and
to start or block the determined vehicle function.

15. A method for accessing an assignment rule of a control unit of a motor vehicle, wherein the assignment rule comprises at least one assignment by means of which at least one vehicle function of the motor vehicle has been assigned to at least one predefined event of the motor vehicle via at least one first adjacence list stored on a memory device of the control unit, the method comprising the steps of:
when the assignment rule is read-accessed
starting a read-access function which via the first adjacence list determines the assignment of the vehicle function to the predefined event,
when the assignment rule is write-accessed
carrying out a check to determine whether the assignment, requiring to be written, of the vehicle function to the predefined event exists,
starting a write-access function that will adjust the first adjacence list as a function of the assignment requiring to be written if the assignment of the vehicle function to the predefined event does not exist.

16. The method according to claim 15, wherein
when the assignment rule is read-accessed
a condition parameter is determined that is assigned to a predefined condition assigned to the predefined event and to the assigned vehicle function in such a way that the assigned vehicle function will be started or blocked only if the predefined event fulfills the condition, with the condition parameter having been assigned to the assignment of the vehicle function to the predefined event,
when the assignment rule is write-accessed
the condition parameter is assigned to the corresponding assignment, requiring to be written, of the vehicle function to the predefined event.

17. The method according to claim 15, wherein a length of at least one of: the first adjacence list, the second adjacence list and a number of the adjacence lists is/are predefined during write accessing.

18. The method according to claim 15, wherein the assignments of a plurality of vehicle functions to in each case at least one of the predefined events are adjusted during write accessing and wherein the adjacence lists are adjusted accordingly during the one instance of write accessing.

19. The method according to claim 15, wherein
when the assignment rule is read-accessed
the determined assignment of the vehicle function to the predefined event is written by the read-access function to the memory device as an array,
the array with the assignment of the vehicle function to the predefined event is read
when the assignment rule is write-accessed
the assignment, requiring to be written, of the vehicle function to the predefined event is written to the memory device as an array,
a check is carried out to determine whether the assignment requiring to be written exists as a function of the array,
the write-access function is started that will adjust the first adjacence list as a function of the array if the assignment of the vehicle function to the predefined event does not exist.

20. The method according to claim 19, wherein the assignment of a plurality of vehicle functions to the predefined event is written to the memory device in a manner distributed among a plurality of arrays.

21. The method according to claim 19, wherein a regular check is carried out on expiration of a predefined second period of time to determine whether the array on the memory device has been updated and wherein the array will be read and/or wherein the adjacence lists will be adjusted as a function of the array if the array has been updated.

22. A device for accessing an assignment rule of a control unit of a motor vehicle, with the assignment rule comprising at least one assignment by means of which at least one vehicle function of the motor vehicle has been assigned to at least one predefined event of the motor vehicle via at least one first adjacence list stored on a memory device of the control unit,
wherein the device is operable
when the assignment rule is read-accessed, to start a read-access function which via the first adjacence list determines the assignment of the vehicle function to the predefined event,
when the assignment rule is write-accessed,
to check whether the assignment, requiring to be written, of the vehicle function to the predefined event exists,
to start a write-access function that will adjust the first adjacence list as a function of the assignment requiring to be written if the assignment of the vehicle function to the predefined event does not exist.

23. A computer-program product comprising a computer-readable medium having program instructions which when executed by a computer perform the step of producing at least one first adjacence list as a function of a matrix
whose row values are representative of at least one predefined event of a motor vehicle or of at least one predefined vehicle function of a motor vehicle and whose column values are representative of at least one of: at least one predefined vehicle function CT) and at least one predefined event and
by means of which the vehicle function has been assigned to the predefined event.
